(19) United States
(12) Patent Application Publication
(10) Pub. No.: US 2025/0286985 A1
(43) Pub. Date: Sep. 11, 2025

(54) ELECTRIC CIRCUIT AND PROJECTOR

(71) Applicant: TriLite Technologies GmbH, Wien (AT)

(72) Inventors: Gerhard SCHMID, Waldkirchen (AT); Franz Josef MAIER, Poertschach am Woerthersee (AT); Manuel DORFMEISTER, Wien (AT); Joerg REITTERER, Brunn am Gebirge (AT)

(21) Appl. No.: 19/068,619

(22) Filed: Mar. 3, 2025

(30) Foreign Application Priority Data
Mar. 7, 2024 (EP) 24162102.8

(51) Int. Cl. H04N 9/31; G02B 26/10

(52) U.S. Cl. CPC H04N 9/3188; G02B 26/105; H04N 9/3135

(57) ABSTRACT

An electric circuit determines a reflection vector of a light beam incident on and reflected by an oscillating mirror, and comprises an input configured to obtain coordinates of a mirror normal vector of the oscillating mirror and of an incidence vector of the incident light beam in a common three-dimensional coordinate system; a projection sub-circuit configured to compute a dot product of said mirror normal vector and said incidence vector from the obtained coordinates, and each coordinate of a projection vector as a product of the respective coordinate of the mirror normal vector and said dot product times minus two; and a summation sub-circuit configured to add the computed projection vector to the incidence vector to determine the reflection vector. A projector utilises the electric circuit to control a light source emitting said light beam.

### CROSS-REFERENCE TO RELATED APPLICATIONS

This application claims priority to European Patent Application No. 24 162 102.8 filed Mar. 7, 2024, the disclosure of which is incorporated herein by reference.

### TECHNICAL FIELD

The present disclosed subject matter relates to an electric circuit for determining a reflection vector of a light beam incident on and reflected by an oscillating mirror. The disclosed subject matter further relates to a projector utilising the electric circuit for controlling a light source emitting said light beam.

### BACKGROUND

Projectors employing an oscillating mirror that reflects and thereby scans a light beam across a scanning area are used, e.g., in virtual reality (VR) or augmented reality (AR) glasses, helmets or head-up displays (HUDs) for a broad range of applications like navigation, training, entertainment, education or work. In these cases, the scanning area is the retina of an eye, an augmented reality (AR) combiner waveguide, another combiner optics, etc.; in other cases, the scanning area may be a board, projection screen, poster, or the like. Projectors of that kind have a light source which emits a single-or multi-coloured light beam carrying an image comprised of pixels onto the oscillating mirror. The mirror, e.g., a micro-electro-mechanical-system (MEMS) mirror or a galvo mirror, oscillates about two axes to reflect the light beam into subsequent directions, one direction per pixel of the image, in order to two-dimensionally scan the light beam across the scanning area according to a scan pattern like a raster pattern, a Lissajous pattern, a spiral pattern, etc.

To project each pixel in the intended direction towards the scanning area at the corresponding mirror orientation, the pixel retrieval from a memory and the pixel dependent control of the light source have to be synchronised with the mirror oscillation. To this end, it is known to predetermine a sequence of pixels which corresponds to the order in which the pixels are to be projected according to the scan pattern. This is done either by measuring or by simulating the path of the reflected light beam from the mirror towards the scanning area in a central processing unit (CPU). The predetermined sequence of pixels is then stored in a memory, and the pixels are retrieved therefrom sequentially according to their sequence, often synchronised by a vertical and/or horizontal synchronisation signal (known as “HSYNC” and “VSYNC”) from a mirror driver.

However, both simulating the light path of the reflected light beam in a CPU as well as measuring the sequence of pixels are elaborate, time-consuming and hence power consuming tasks. Moreover, storing the sequence of pixels in addition to the colour values of the pixels of the image requires a large and thus rather slowly accessible memory which constrains the achievable image resolution and/or frame rate. Furthermore, employing the predetermined fixed sequence of pixels does not allow to account for changes in the mirror oscillation and hence the scan pattern, e.g., caused by long-term drifts or short-term mirror or control loop fluctuations, etc. While long-term changes of the scan pattern may eventually be compensated for by an elaborate re-determination of the sequence of pixels, a compensation of short-term changes of the scan pattern is most often unfeasible.

### BRIEF SUMMARY

It is an object of the present disclosed subject matter to provide an electric circuit and a projector that allow for a fast and accurate determination of an indication of the pixel that is to be projected and thus for a tight synchronisation of the mirror and the light source of said projector.

In a first aspect of the disclosed subject matter this object is achieved with an electric circuit for determining a reflection vector of a light beam incident on and reflected by an oscillating mirror, comprising
an input configured to obtain coordinates of a normalised mirror normal vector of the oscillating mirror and of an incidence vector of the incident light beam in a common three-dimensional coordinate system;
a projection sub-circuit connected to the input and configured to compute a dot product of said mirror normal vector and said incidence vector from the obtained coordinates and to compute each coordinate of a projection vector as a product of the respective coordinate of the mirror normal vector and said dot product times minus two; and
a summation sub-circuit connected to the input and to the projection sub-circuit and configured to add the computed projection vector to the incidence vector to determine the reflection vector of the light beam.

The disclosed subject matter is based on the provision of a dedicated electric circuit, i.e., dedicated hardware, for the task of determining the reflection vector of the light beam after its reflection by the oscillating mirror. The projection sub-circuit is dedicated to compute the projection vector which is the difference between the reflected vector and the incidence vector of the light beam, and the summation sub-circuit is dedicated to add the incidence and projection vectors, to obtain the reflection vector from the input mirror normal and incidence vectors.

Providing a dedicated hardware for the task of determining the reflection vector has several advantages. The computation of the projection vector and the addition of the projection and incidence vectors can be carried out by the dedicated projection and summation sub-circuits in a fast way, in particular when they are embodied as an application specific integrated circuit (ASIC), a field-programmable gate array (FPGA), or the like. This allows to determine on-the-fly, i.e., during operation of a projector, the reflection vector and, in turn, the corresponding pixel that is to be retrieved and projected by the light source of the projector. Hence, an intricate predetermination and storage of a large sequence of pixels is not required. Not requiring the storage of the pixel sequence, the projector's memory may either be smaller and faster accessible increasing the achievable frame rate, or may store more pixels increasing the achievable image resolution. The determination of the reflection vector on-the-fly based on the mirror normal vector of the current mirror orientation by design accounts for changes in the mirror oscillation and the scan pattern. Thus, drifts and fluctuations are compensated for by default, which is why the electric circuit facilitates an accurate determination of the reflection vector and of the corresponding pixel. Moreover, using a dedicated hardware for determining the reflection vector allows to carry out this task in an energy efficient way and within a compact electric circuit saving battery power and installation space in the projector.

The projection and summation sub-circuits may be embodied in many ways and may utilise many combinations of known analogue or digital electronic elements such as multipliers, adders, memory cells, delay elements, etc. to determine the dot product, the projection vector, and the reflection vector. Three advantageous embodiments, which may optionally be combined, shall be detailed in the following.

In the first advantageous embodiment, the projection sub-circuit, for computing the dot product, comprises
a first multiplier group having a first multiplier configured to multiply first coordinates of the mirror normal vector and the incidence vector to determine a first product, a second multiplier configured to multiply second coordinates of the mirror normal vector and the incidence vector to determine a second product, and a third multiplier configured to multiply third coordinates of the mirror normal vector and the incidence vector to determine a third product, and
an adder configured to add said first, second and third products to determine said dot product.

In this way, all the three products required for forming the dot product are computed particularly fast by the three multipliers of the first multiplier group, optionally even in parallel, and added together by the single downstream adder to efficiently form the dot product.

In the second advantageous embodiment, the projection sub-circuit, for computing the projection vector, comprises
a multiplicator configured to multiply said dot product by minus two to determine a scaled dot product, and
a second multiplier group having a first multiplier configured to multiply the first coordinate of the mirror normal vector by the scaled dot product to determine a first coordinate of the projection vector, a second multiplier configured to multiply the second coordinate of the mirror normal vector by the scaled dot product to determine a second coordinate of the projection vector, and a third multiplier configured to multiply the third coordinate of the mirror normal vector by the scaled dot product to determine a third coordinate of the projection vector.

Thereby, the projection vector is computed in a small number of steps and, thus, efficiently by a small number of electronic elements as it is the dot product—i.e., one single scalar instead of, e.g., the three coordinates of the mirror normal vector or the incidence vector—that is scaled by the factor minus two to form the scaled dot product. The scaled dot product, in turn, is multiplied by the mirror normal vector by the three multipliers of the second multiplier group, optionally even in parallel, to compute the projection vector in a particularly fast way.

In the third advantageous embodiment, the summation sub-circuit, for determining the reflection vector, comprises a first adder configured to add the first coordinate of the projection vector to the first coordinate of the incidence vector to determine a first coordinate of the reflection vector, a second adder configured to add the second coordinate of the projection vector to the second coordinate of the incidence vector to determine a second coordinate of the reflection vector, and a third adder configured to add the third coordinate of the projection vector to the third coordinate of the incidence vector to determine a third coordinate of the reflection vector.

Similar to the above-mentioned multiplications by the first and second multiplier groups, all three coordinates of the reflection vector can be determined by the three adders, e.g., in parallel and, thus, particularly fast.

In order to take into account an inclination of the scanning area with respect to the coordinate system, in a favourable embodiment, the input is further configured to obtain a sine and a cosine of each of a first and/or a second orientation angle indicating an orientation of the scanning area, and the electric circuit comprises a rotation sub-circuit connected to the input and to the summation sub-circuit and configured to rotate the determined reflection vector by said first and/or second orientation angle. In this embodiment, the coordinates of the reflection vector are determined by means of said rotation/s with respect to the scanning area, e.g. in a second coordinate system lying in the scanning area. Hence, the reflection vector rotated by the orientation angle/s is determined as seen from the inclined scanning area which eases a pixel retrieval in many applications.

In an optional variant of this embodiment, the input comprises an angle function sub-circuit and is configured to receive said first and/or said second orientation angle, wherein the angle function sub-circuit has one or more sine units configured to obtain said sine of the first and/or second orientation angle by computation and one or more cosine units configured to obtain said cosine of the first and/or second orientation angle by computation. Consequently, the angle functions are as well determined in dedicated sub-circuits in hardware and, thus, particularly fast and efficiently.

The rotation sub-circuit may be embodied in many ways. In a beneficial embodiment, for rotating the reflection vector by said first orientation angle, the rotation sub-circuit comprises
a first multiplier configured to multiply the sine of the first orientation angle by the third coordinate of the reflection vector to determine a first summand,
a second multiplier configured to multiply the cosine of the first orientation angle by the first coordinate of the reflection vector to determine a second summand,
a first adder configured to add the first and second summands to determine a first coordinate of the reflection vector rotated by the first orientation angle,
a third multiplier configured to multiply the cosine of the first orientation angle by the third coordinate of the reflection vector to determine a third summand,
a fourth multiplier configured to multiply the sine of the first orientation angle by the first coordinate of the reflection vector to determine a fourth summand, and
a second adder configured to add the third summand and a negative of the fourth summand to determine a third coordinate of the reflection vector rotated by said first orientation angle.

The provision of the four multipliers allows to compute the four summands particularly fast, optionally in parallel, and energy efficiently. The same accounts for the two adders which allow to add the respective summands in a fast and energy efficient way, e.g., in parallel. As a result, carrying out the rotation by the first orientation angle on-the-fly during operation of the projector is facilitated.

To further rotate the reflection vector by said second orientation angle in an energy efficient and fast way, it is favourable when the rotation sub-circuit further comprises
a fifth multiplier configured to multiply the sine of the second orientation angle by the third coordinate of the reflection vector rotated by said first orientation angle to determine a fifth summand,
a sixth multiplier configured to multiply the cosine of the second orientation angle by the second coordinate of the reflection vector rotated by said first orientation angle to determine a sixth summand,
a third adder configured to add the sixth summand and a negative of the fifth summand to determine a second coordinate of the reflection vector rotated by said second orientation angle,
a seventh multiplier configured to multiply the cosine of the second orientation angle by the third coordinate of the reflection vector rotated by said first orientation angle to determine a seventh summand,
an eighth multiplier configured to multiply the sine of the second orientation angle by the second coordinate of the reflection vector rotated by said first orientation angle to determine an eighth summand,
a fourth adder configured to add the seventh and eighth summands to determine a third coordinate of the reflection vector rotated by said second orientation angle.

In many applications, vertical and horizontal impingement angles under which the reflected light beam impinges onto the scanning area indicate the pixel that is to be retrieved and projected, e.g., when projecting onto a waveguide combiner or directly into the user's eye. To determine these impingement angles fast and efficiently, the electric circuit optionally comprises an angle determination sub-circuit configured to determine, from the determined reflection vector, the vertical and the horizontal impingement angle of the light beam on the scanning area, seen from the scanning area.

The electric circuit may determine the reflection vector or the impingement angles only once, e.g., to calibrate a projector. In a favourable embodiment, however, the electric circuit is configured to determine said reflection vector or said impingement angles repeatedly, e.g. continuously, for successive orientations of the oscillating mirror. Consequently, the electric circuit allows to perform the determination of the pixel to be retrieved also in dependence on the reflection vector or on the impingement angles on-the-fly.

The input obtains the coordinates of the mirror normal vector from a physical measurement, either by directly receiving these coordinates from a sensor, or by transforming sensed data indicative of these coordinates received from a sensor into these coordinates. In an advantageous embodiment of the latter, the input comprises a transformation sub-circuit and is configured to receive a first oscillation angle of said mirror about a first axis and a second oscillation angle of said mirror about a second axis, wherein the transformation sub-circuit is configured to obtain the coordinates of the mirror normal vector by computation from the first and second oscillation angles. Compared to the mirror normal vector, the two oscillation angles can be sensed more easily, e.g., by a sensor connected to or included in the mirror driver. Hence, this embodiment facilitates the provision of the mirror normal vector by computing the same from the more easily accessible orientation angles.

It is particularly advantageous, when the transformation sub-circuit comprises
a first sine unit configured to compute a sine of the first oscillation angle to obtain the first coordinate of the mirror normal vector,
a first cosine unit configured to compute a cosine of the first oscillation angle,
a second sine unit configured to compute a sine of the second oscillation angle,
a second cosine unit configured to compute a cosine of the second oscillation angle,
a first multiplier connected to the first cosine unit and the second sine unit and configured to multiply the cosine of the first oscillation angle by the sine of the second oscillation angle and by minus one to obtain the second coordinate of the mirror normal vector, and
a second multiplier connected to the first cosine unit and the second cosine unit and configured to multiply the cosine of the first oscillation angle by the cosine of the second oscillation angle to obtain the third coordinate of the mirror normal vector.

The sine and cosine units of the transformation sub-circuit compute the required sine and cosine of each of the first and second oscillation angles in a fast way, optionally even in parallel. Likewise, the multipliers downstream of the sine and cosine units compute the second and third coordinates of the mirror normal vector fast, optionally even in parallel.

The mirror may reflect one light beam to project a black-and-white or greyscale image, or several light beams, e.g., a red, a green and a blue light beam, to project a colour image or several black-and-white or greyscale images next to each other. In one embodiment aiming at a reflection of several light beams, the electric circuit advantageously comprises one transformation sub-circuit and at least two groups of sub-circuits, each group having at least one projection sub-circuit and one summation sub-circuit, wherein each group is connected to the transformation sub-circuit and configured to determine the reflection vector of a respective light beam. In this embodiment, one and the same computation of the mirror normal vector by the transformation sub-circuit is efficiently utilised (quasi: recycled) for the downstream determination of the reflection vectors of at least two light beams by the groups of sub-circuits. Optionally, each group may further have a rotation sub-circuit to rotate the respective light beam, and further optionally, in addition or alternatively to the rotation sub-circuit, an angle determination sub-circuit to determine the impingement angles of the respective light beam.

In an optional embodiment, the electric circuit further comprises a sensor connected to the input and configured to sense at least one of the coordinates of the incidence vector, the coordinates of the mirror normal vector, the first oscillation angle, the second oscillation angle, the first orientation angle and the second orientation angle, and to transmit the same to the input. Thus, the electric circuit itself can sense the required data for determining the reflection vector and/or the impingement angles.

In a further optional embodiment, the electric circuit comprises a light source driver configured to drive a light source emitting said light beam or, where applicable, said several light beams in dependence on the determined reflection vector or impingement angles. Hence, the determined reflection vector or impingement angles are utilised by the electric circuit itself to retrieve the desired pixel indicating an intensity of the light beam/s and to control the light source in dependence on the retrieved pixels.

In a second aspect the present disclosed subject matter provides for a projector for projecting an image comprised of pixels onto a scanning area, comprising
a light source configured to emit a light beam carrying said image;
a mirror configured to oscillate about two axes in order to reflect the light beam across the scanning area in order to project the image onto the scanning area; and
an electric circuit as exemplified above, wherein the light source driver is connected to the light source to drive the same in order to project, for each determined reflection vector or pair of impingement angles, the desired pixel of the image.

The projector utilises the electric circuit in order to correctly project the image, i.e., each pixel thereof at the correct mirror orientation. To this end, the projector may make use of any of the above-mentioned embodiments of the electric circuit to achieve the above-mentioned advantages.

### BRIEF DESCRIPTION OF THE DRAWINGS

The disclosed subject matter will now be described by means of exemplary embodiments thereof with reference to the enclosed drawings, in which show:

FIG. 1 a projector comprising an electric circuit according to the disclosed subject matter, the projector projecting an image on a scanning area, in a schematic diagram.

FIG. 2 an oscillating mirror of the projector of FIG. 1, in a schematic top view;

FIG. 3 a light beam emitted by a light source of the projector of FIG. 1, incident on and reflected by the mirror of FIG. 2 under respective incidence and reflection vectors and impinging on the scanning area of FIG. 1, in a schematic side view;

FIG. 4 an embodiment of the electric circuit of FIG. 1 for determining the reflection vector of the light beam of FIG. 2, in a schematic circuit diagram;

FIG. 5 a further embodiment of the electric circuit of FIG. 1 for determining the reflection vector of the light beam of FIG. 2, in a schematic circuit diagram;

FIG. 6 the electric circuit of FIG. 4 or 5 further comprising a rotation sub-circuit for rotating the determined reflection vector by a first orientation angle, in a schematic circuit diagram;

FIG. 7 the electric circuit of FIG. 6 comprising an extended rotation sub-circuit for rotating the determined reflection vector also by a second orientation angle, in a schematic circuit diagram;

FIG. 8 the electric circuit of FIG. 6 further comprising a transformation sub-circuit for determining impinging angles under which the light beam impinges on the scanning area of FIGS. 1 and 3, in a schematic circuit diagram;

FIG. 9 the electric circuit of FIG. 4 or 5 further comprising a transformation sub-circuit for computing coordinates of a mirror normal vector, in a schematic circuit diagram, and

FIG. 10 an embodiment of the electric circuit of FIG. 1 for determining impingement angles of several light beams, in a schematic block diagram.

### DETAILED DESCRIPTION

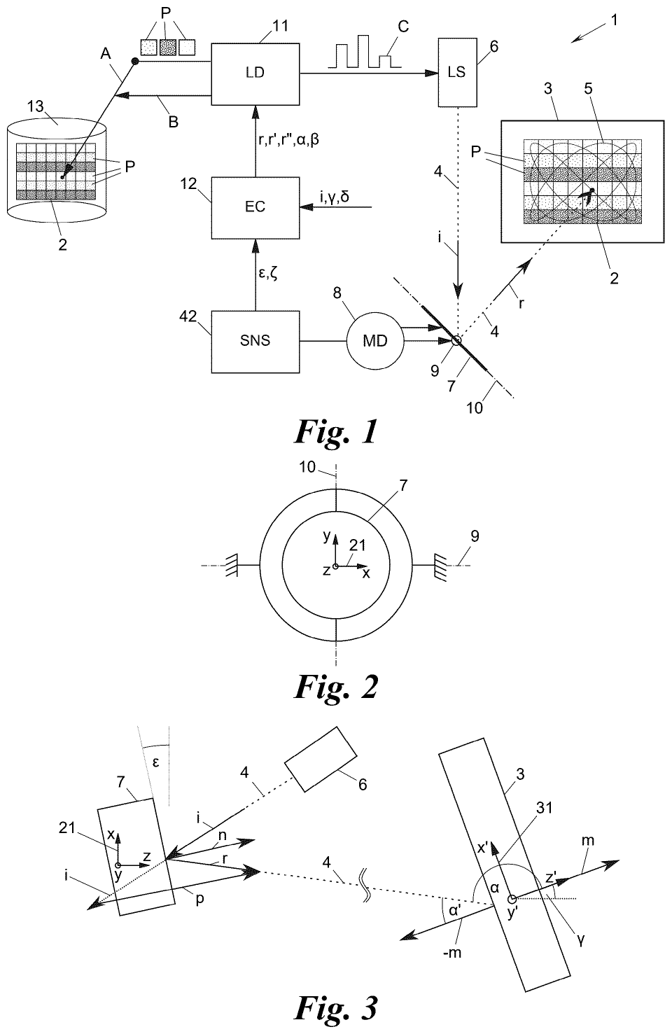

FIG. 1 shows a projector 1 projecting an image 2 onto a scanning area 3 by scanning the scanning area 3 with a pulsed or continuous light beam 4 according to a scan pattern 5 like a raster pattern, a Lissajous pattern, a spiral pattern or the like to draw, one after the other, pixels P of the image 2. The image 2 may or may not have a pixel resolution according to a conventional image or video standard, e.g., full HD (1920×1080 pixels), UHD (3840×2160 pixels), 4K (4096×2160 pixels) etc., and the scan pattern may or may not densely cover the scanning area 3; however, for illustrational purposes an image 2 with only few pixels P and a simple, coarse scan pattern 5 are shown in FIG. 1.

The image 2 is projected for at least one frame duration and may be part of a movie or be a single image, e.g. a photo, a rendering etc. to be projected for a longer period of time. The projector 1 may project the light beam 4 onto any kind of flat or curved scanning area 3, such as a board, a projection screen, a poster, the retina of an eye, an augmented reality (AR) combiner waveguide, another combiner optics, or the like. Accordingly, the projector 1 may be part of a projection system, AR or VR (virtual reality) glasses, a helmet, a head-up display, a smartphone, etc.

As shown in FIGS. 1 to 3, the projector 1 has a light source 6 that emits the light beam 4 which carries the image 2 pixel-by-pixel in a time-multiplexed manner. The projector 1 further has an oscillating mirror 7 like a micro-electro-mechanical-system, MEMS, or galvo mirror, that reflects and thereby scans the emitted light beam 4 across the scanning area 3. To this end, the mirror 7 may, e.g., be gimbal-mounted as shown in FIG. 2 or kinematically-mounted (not shown). The mirror 7 is driven by a mirror driver 8 to oscillate about two different axes 9, 10, in order to reflect the emitted light beam 4 incident along an incidence vector i towards the scanning area 3 according to said scan pattern 5, at any point in time along a corresponding reflection vector r (FIG. 3). The reflection vector r and the incidence vector i differ by an imaginary projection vector p as illustrated in FIG. 3 by the vector triangle spanned by the shifted incidence vector i (dotted arrow), the projection vector p and the reflection vector r.

The light source 6 may be any light source known in the art, e.g., an incandescent lamp, a gas, liquid or solid laser, a laser diode, an LED, microLED (μLED), super luminescent light emitting diode (SLED), etc. The light source 6 is driven by a light source driver 11 according to the desired pixels P of the image 2. In case the light source 6 projects a mono-colour, black and white, or grey scale image 2 with a mono-coloured light beam 4, each pixel P comprises a single colour value, e.g., a brightness or intensity value, and in case the light source 6 projects a multi-colour image 2 with several light beams of different colours, each pixel comprises several colour values, e.g., RGB values indicating the brightness or intensity of a red, green, and blue colour, YPbPr values, etc.

As shown in FIG. 1, to synchronise the light beam emission by the light source 6 with the orientation of the mirror 7, the light source driver 11 receives, for each point in time, the corresponding reflection vector r (or a rotated reflection vector r′, r″, or a pair of impingement angles α, β as detailed below) from an electric circuit 12, which may optionally include or be part of the light source driver 11. Symbolised by the pointer A that points at the corresponding pixel P and is controlled by the light source driver 11 (cf. arrow B), the light source driver 11 retrieves the corresponding pixel P of the image 2, that is indicated by the received reflection vector r (or the rotated reflection vector r′, r″, or the pair of impingement angles α, β), from a memory 13 in which the desired pixel colour value/s are stored for each pixel P of the respective image 2. In turn, the light source driver 11 drives the light source 6 according to the retrieved pixel P, e.g. by a driving current C that corresponds to the pixel colour value/s. Consequently, for each reflection vector r (or rotated reflection vector r′, r″, or pair of impingement angles α, β) the desired pixel P of the image 2 is projected onto the scanning area 3.

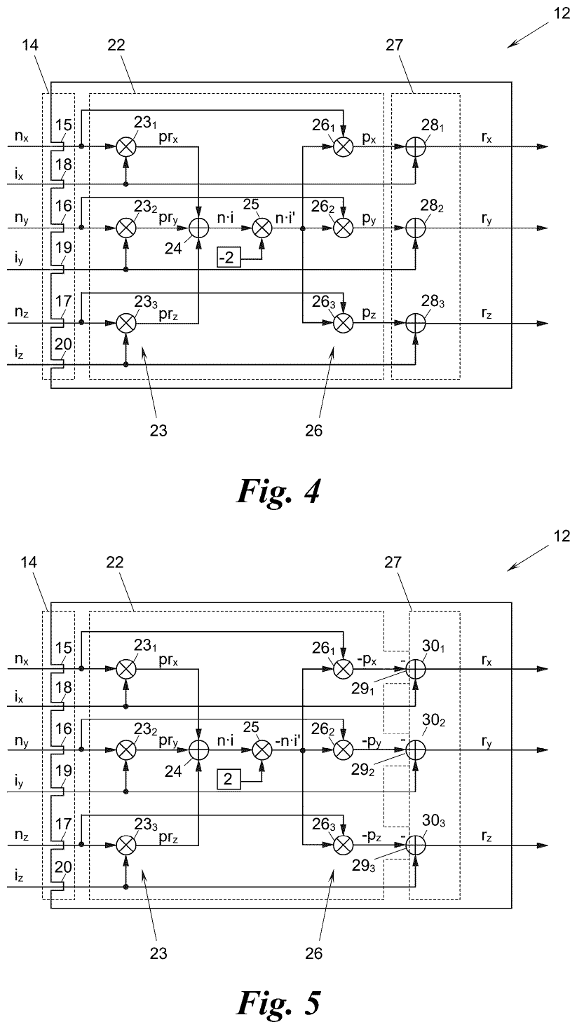

With reference to FIG. 4, the determination of the reflection vector r by the electric circuit 12 shall be described in detail.

As shown in the example of FIG. 4, the electric circuit 12 is a hardware circuit and has an input 14 with three ports 15, 16, 17, each for obtaining one coordinate nₓ, n_{y}, n_{z} of a normalised mirror normal vector n, and three further ports 18, 19, 20, each for obtaining one coordinate iₓ, i_{y}, i_{z} of the (optionally normalised) incidence vector i. Alternatively, the input 14 may have a different number of ports to receive the coordinates, e.g., one port receiving the coordinates one after the other. Moreover, the input 14 may optionally receive non-normalised coordinates of the mirror normal vector n and obtain the normalised coordinates nₓ, n_{y}, n_{z} by normalising the non-normalised coordinates.

The coordinates nₓ, n_{y}, n_{z}, iₓ, i_{y}, i_{z} of the mirror normal vector n and the incidence vector i are provided in a common three-dimensional coordinate system 21 (FIG. 3). In the example of FIGS. 2 and 3, the common coordinate system 21 is located in the mirror 7 with one axis (here: the z-axis) being parallel to the mirror normal vector n in a reference orientation of the mirror 7 that may, e.g., coincide with a resting or central orientation of the mirror 7 (FIG. 2). Alternatively, the common coordinate system 21 may be positioned and oriented differently, e.g., co-moving with the mirror 7.

Returning to FIG. 4, the electric circuit 12 further has a projection sub-circuit 22 that is connected to the input 14. The projection sub-circuit 22 computes the dot product (sometimes called “inner product”) n·i of the mirror normal and incidence vectors n, i.

To this end, in the example of FIG. 4, the projection sub-circuit 22 has a first multiplier group 23 and, downstream thereof, an adder 24. The first multiplier group 23 has a first multiplier 23₁ which multiplies the first coordinate nₓ of the mirror normal vector n by the first coordinate iₓ of the incidence vector i to determine a first product prₓ, a second multiplier 23₂ which multiplies the second coordinate n_{y} of the mirror normal vector n by the second coordinate i_{y} of the incidence vector i to determine a second product pr_{y}, and a third multiplier 23₃ which multiplies the third coordinate n_{z} of the mirror normal vector n by the third coordinate i_{z} of the incidence vector i to determine a third product pr_{z}. The adder 24 adds the first, second and third products prₓ, pr_{y}, pr_{z} to determine the dot product n·i.

Therefrom, the projection sub-circuit 22 computes the projection vector p as a product of the normalised mirror normal vector n and the dot product n·i times minus two, i.e. as p=n·(n·i)·(−2). To this end, in the example of FIG. 4, the projection sub-circuit 22 has a multiplicator 25 and, downstream thereof, a second multiplier group 26. The multiplicator 25 multiplies the dot product n·i by minus two to determine a scaled dot product n·i′ as −2·(n·i). The second multiplier group 26 has a first multiplier 26₁ which multiplies the first coordinate nₓ of the mirror normal vector n by the scaled dot product n·i′ to determine a first coordinate pₓ of the projection vector p, a second multiplier 26₂ which multiplies the second coordinate n_{y} of the mirror normal vector n by the scaled dot product n·i′ to determine a second coordinate p_{y} of the projection vector p, and a third multiplier 26₃ which multiplies the third coordinate n_{z} of the mirror normal vector n by the scaled dot product n·i′ to determine a third coordinate p_{z} of the projection vector p.

Downstream of the projection sub-circuit 22, the electric circuit 12 comprises a summation sub-circuit 27 that is connected to the ports 18-20 and to the projection sub-circuit 22 and adds the projection vector p to the incidence vector i to determine, as a result of the adding, the reflection vector r.

In the example of FIG. 4, the summation sub-circuit 27 comprises a first adder 28₁ which adds the first coordinate pₓ of the projection vector p to the first coordinate iₓ of the incidence vector i to determine a first coordinate rₓ of the reflection vector r, a second adder 28₂ which adds the second coordinate p_{y} of the projection vector p to the second coordinate i_{y} of the incidence vector i to determine a second coordinate r_{y} of the reflection vector r, and a third adder 28₃ which adds the third coordinate p_{z} of the projection vector p to the third coordinate i_{z} of the incidence vector i to determine a third coordinate r_{z} of the reflection vector r.

With respect to the multiplicator 25, it is noted, that the multiplication by minus two may be carried out in two steps by multiplying any of the following terms (a) the mirror normal vector n, (b) the incidence vector i, (c) the products prₓ, pr_{y}, pr_{z}, (d) the dot product n·i, or (e) the mirror normal vector n times the dot product n′i, by two, and the same or another one of these terms (a)-(e) by minus one, or in one step by multiplying any of the terms (a)-(e) by minus two.

Accordingly, FIG. 5 shows an alternative embodiment of the electric circuit 12 determining the reflection vector r. Here, the input 14 as well the first multiplication group 23, the adder 24 and the second multiplication group 26 of the projection sub-circuit 22 are embodied as in FIG. 4. However, the multiplicator 25 multiplies the dot product n·i (term (d) above) by two instead of minus two to obtain a negative-n′i′ of the above-mentioned scaled dot product n′i′ and the projection sub-circuit 22 applies a multiplication by minus one at a later stage by means of inverting inputs 29₁, 29₂, 29₃ of adders 30₁, 30₂, 30₃.

In one embodiment, the determined reflection vector r is directly transmitted to the light source driver 11 which utilises the same to drive the light source 6 in dependence thereon. The light source driver 11 may utilise the reflection vector r in many ways.

In a first example, the light source driver 11 may retrieve a pixel P that is more to the right in the image 2, when the x-coordinate rₓ of the reflection vector r is larger, and that is more to the top in the image 2, when the y-coordinate r_{y} of the reflection vector r is larger and vice versa. In a second example where the scanning area 3 is flat and normal to the z-axis of the coordinate system 21, the incidence vector i (or the reflection vector r) may be scaled such that the z-coordinate r_{z} of the reflection vector r corresponds to the distance between the mirror 7 and the scanning area 3. Then, the x- and y-coordinates of the rₓ, r_{y} of the reflection vector r may correspond to the x- and y-coordinates of the impingement point of the light beam 4 on the scanning area 3 such that the corresponding pixel P can be retrieved on the basis of the impingement point indicated by the x- and y-coordinates rₓ, r_{y} of the reflection vector r. For example, assuming a 1920×1080 pixel image 2, a column index of the pixel P to be retrieved may be computed as ((rₓ−r_{x,min})/(r_{x,max}−r_{x,min}))·1920, and a row index of the pixel P to be retrieved may be computed as ((r_{y}−r_{y,min})/(r_{y,max}−r_{y,min}))·1080, with r_{x,max} and r_{y,max} denoting the maximum value and r_{x,min} and r_{y,min} denoting the minimum value of the respective coordinate of the reflection vector r. Of course, other computations of the pixel P on the basis of the reflection vector r may be employed, for instance, a computation based on another linear or a non-linear assignment of any of the coordinates rₓ, r_{y}, r_{z} to the pixel indices or to the memory addresses of the pixels may be be utilised, e.g., in dependence on the arrangement of the pixels P in the memory 13, the physical arrangement of the light source 6, the mirror 7 and/or the scanning area 3.

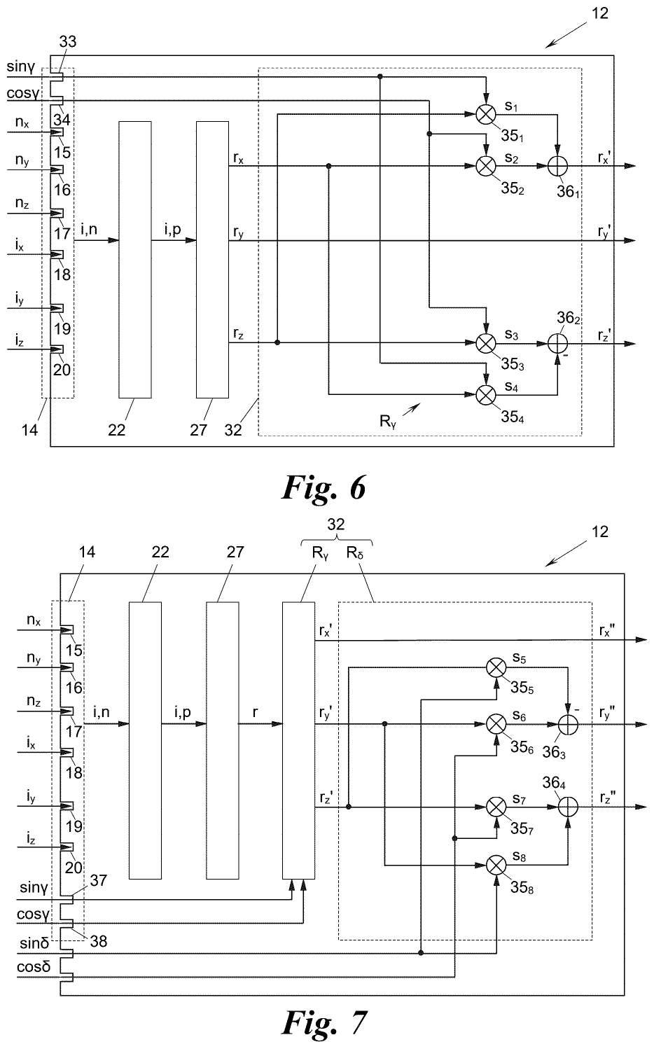

In further embodiments, e.g., the ones shown in FIGS. 6-8, the determined reflection vector r is further processed by the electric circuit 12 to facilitate the driving of the light source 6 by the desired pixel P for the corresponding orientation of the mirror 7.

With reference to FIGS. 3 and 6, a rotation of the determined reflection vector r by a first orientation angle γ of the scanning area 3 to consider a possible inclination of the scanning area 3 in relation to the coordinate system 21 shall now be described. As indicated in FIG. 3, the common coordinate system 21 and the scanning area 3 may be inclined with respect to one another by the first orientation angle γ (here: by a 20° rotation in relation to the common coordinate system 21 about the y-axis).

To determine the impingement of the reflection vector r with respect to the scanning area 3, a determination of coordinates of the reflection vector r in a further coordinate system 31, e.g. one that has one axis (in FIG. 3: exemplarily its z′-axis) parallel to the scanning area's normal vector m (likewise: to its oppositely directed form −m), may be carried out by rotating the reflection vector r. To this end, the electric circuit 12 in the example of FIG. 6 further comprises a rotation sub-circuit 32. The rotation sub-circuit 32 is connected to the summation sub-circuit 27 and to two further ports 33, 34 of the input 14 which obtain a sine and a cosine of the first orientation angle γ. The rotation sub-circuit 32, in turn, rotates the reflection vector r from the summation sub-circuit 27 by the first orientation angle γ on the basis of the sine and cosine thereof.

For rotating the reflection vector r about said first orientation angle γ, the exemplary rotation sub-circuit 32 of FIG. 6 comprises a first multiplier 351 which multiplies the sine of the first orientation angle γ by the third coordinate r_{z} of the reflection vector r to determine a first summand s₁, a second multiplier 35₂ which multiplies the cosine of the first orientation angle γ by the first coordinate rₓ of the reflection vector r to determine a second summand s₂, and a first adder 36₁ which adds the first and second summands s₁, s₂to determine a first coordinate rₓ′ of the reflection vector r rotated by the first orientation angle γ (also called the “first” rotated reflection vector r′ in the following).

The rotation sub-circuit 32 further comprises a third multiplier 35₃ which multiplies the cosine of the first orientation angle γ by the third coordinate r_{z} of the reflection vector r to determine a third summand s₃, a fourth multiplier 35₄ which multiplies the sine of the first orientation angle γ by the first coordinate rₓ of the reflection vector r to determine a fourth summand s₄, and a second adder 36₂ which adds the third summand s₃ and a negative of the fourth summand s₄, i.e., subtracts the fourth summand s₄ from the third summand s₃, to determine a third coordinate r_{z}′ of the first rotated reflection vector r′. The second coordinate r_{y} of the reflection vector r is not affected by the exemplary inclination of FIG. 3 and thus equal to a second coordinate r_{y}′ of the first rotated reflection vector r′.

As indicated in FIG. 1, the electric circuit 12 may transmit the first rotated reflection vector r′ to the light source driver 11 for controlling the light source 6 in dependence thereon, e.g., as described above for the (unrotated) reflection vector r. The coordinates rₓ′, r_{y}′, r_{z}′ of the first rotated reflection vector r′ describe the reflection vector r in the further coordinate system 31 and, hence, from the view of the inclined scanning area 3, which eases the retrieval of the desired pixel P for the current mirror orientation and the control of the light source 6 on the basis thereof.

The common coordinate system 21 and the scanning area 3 may be inclined with respect to one another in a further direction, i.e., by a second orientation angle δ about a different second axis. To determine the impingement of the reflection vector r with respect to such an inclined scanning area 3, e.g., in a further coordinate system with an axis parallel to the scanning area normal vector m of such an inclined scanning area 3, the reflection vector r may be further rotated by the second orientation angle δ.

To this end, the electric circuit 12 may comprise the extended rotation sub-circuit 32 shown in the example of FIG. 7, which comprises the multipliers 35₁-35₄, and the adders 36₁, 36₂ of the example of FIG. 6 for a rotation by the first orientation angle γ (denoted by R_{γ}), and four further multipliers 35₅-35₈ and two further adders 36₃, 36₄ for a rotation by the second orientation angle δ (denoted by R_{δ}). The rotation sub-circuit 32 is further connected to two further ports 37, 38 of the input 14 which obtains a sine and a cosine of the second orientation angle δ and rotates the reflection vector r a second time, now about said second axis by the second orientation angle δ on the basis of the sine and cosine of the second orientation angle δ.

To this end, the extended rotation sub-circuit 32 of FIG. 7 comprises a fifth multiplier 35₅ which multiplies the sine of the second orientation angle δ by the third coordinate r_{z}′ of the first rotated reflection vector r′ to determine a fifth summand s₅, a sixth multiplier 35₆ which multiplies the cosine of the second orientation angle δ by the second coordinate r_{y}′ of the first rotated reflection vector r′ to determine a sixth summand s₆, and a third adder 36₃ which adds a negative of the fifth summand s₅ and the sixth summand s₆, i.e., subtracts the fifth summand s₅ from the sixth summand s₆, to determine a second coordinate r_{y}″ of the reflection vector r rotated by the second orientation angle δ (also called “second” rotated reflection vector r″ in the following). The rotation sub-circuit 32 of FIG. 7 further comprises a seventh multiplier 35₇ which multiplies the cosine of the second orientation angle δ by the third coordinate r_{z}′ of the first rotated reflection vector r′ to determine a seventh summand s₇, an eighth multiplier 35₈ which multiplies the sine of the second orientation angle δ by the second coordinate r_{y}′ of the first rotated reflection vector r′ to determine an eighth summand s₈, and a fourth adder 36₄ which adds the seventh summand s₇ and the eighth summand s₈ to determine a third coordinate r_{z}″ of the second rotated reflection vector r. In this example, the first coordinate rₓ′ of the first rotated reflection vector r is not affected by the second rotation and thus equal to a first coordinate rₓ″ of the second rotated reflection vector r″.

As indicated in FIG. 1, the electric circuit 12 may transmit the second rotated reflection vector r″ to the light source driver 11 for controlling the light source 6 in dependence thereon, e.g., as described above for the (unrotated) reflection vector r. The coordinates rₓ″, r_{y}″, r_{z}″ of the second rotated reflection vector r″ describe the reflection vector r in a further coordinate system that lies in the scanning area 3 and is rotated against the common coordinate system 21 by two rotations about two different axes by the respective orientation angles γ, δ, which eases the retrieval of the desired pixel P for the current mirror orientation and the control of the light source 6 on the basis thereof.

The rotation sub-circuit 32 may be embodied different from the examples of FIGS. 6 and 7. For instance, the rotation components R_{γ} and Rₛ—and thus the order of the first and second rotations—may be exchanged, i.e., the components R_{δ} may be arranged upstream the components Ry. This corresponds to a different assignment of the “first”, “second” and “third” coordinates to the x-, y- and z-coordinates of the common coordinate system 21, or—equivalently—to a rotation or inversion of the coordinate system 21. It is stressed that such a different assignment falls under the scope of the appended claims as well. In any case, the orientation angles γ, δ are defined as those angles that indicate the necessary rotations of the reflection vector r to describe the same in a coordinate system that has one axis normal to an inclined scanning area 3.

In some embodiments, e.g., when the scanning area 3 is a combiner of AR or VR glasses, in particular a waveguide combiner, the eye of a user, etc., the pixel P to be projected depends on the impingement angles α, β under which the light beam 4 impinges onto the scanning area 3. The impingement angles α, β may, e.g., be measured in a spherical coordinate system the zenith direction of which corresponds to the z′-axis of the further coordinate system 31. For instance, the vertical impingement angle α may be measured as the polar angle and the horizontal impingement angle β as the azimuth angle in this spherical coordinate system, or vice versa. In any case, the vertical and horizontal impingement angles α, β describe the impingement direction under which the light beam 4 impinges on the scanning area 3 as seen from the scanning area 3, either when looking in the direction of the light beam 4 (as shown in FIG. 3), or when looking in the opposite direction (as indicated by the impingement angle α′ in FIG. 3).

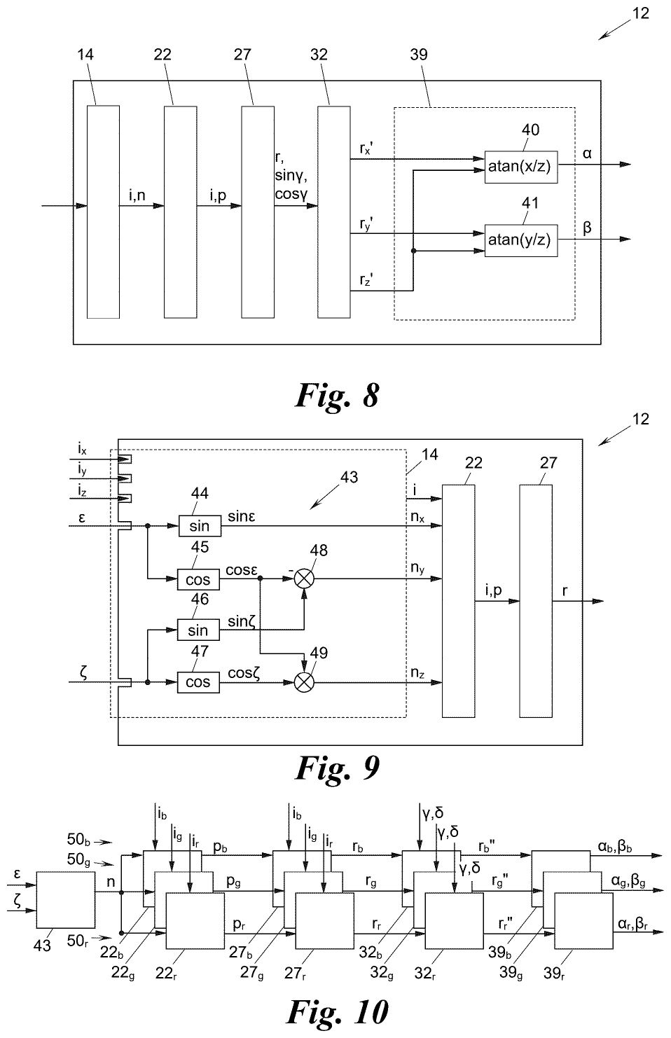

As shown in the example of FIG. 8, the electric circuit 12 may also comprise an angle determination sub-circuit 39 which determines the impingement angles α, β from the reflection vector r (here: from the first rotated reflection vector r′, alternatively from the unrotated reflection vector r or from the second rotated reflection vector r″). In the example of FIG. 8, the angle determination sub-circuit 39 determines the vertical impingement angle α in an arctan unit 40 as the arctangent (atan), i.e. the inverse tangent, of the first coordinate rₓ′ of the first rotated reflection vector r divided by the third coordinate r_{z}′ of the first rotated reflection vector r. The angle determination sub-circuit 39 further determines the horizontal impingement angle β in a further arctan unit 41 as the arctangent (atan) of the second coordinate r_{y}′ of the first rotated reflection vector r divided by the third coordinate r_{z}′ of the first rotated reflection vector r.

In an alternative embodiment (not shown), the angle determination sub-circuit 39 determines the vertical impingement angle α as the arcsine, i.e. the inverse sine, of the first coordinate rₓ of the reflection vector r divided by the norm of the reflection vector r and the horizontal impingement angle β as the arctangent of the second coordinate r_{y} of the reflection vector r divided by the third coordinate r_{z} of the reflection vector r. In yet another embodiment (not shown), the angle determination sub-circuit 39 determines the vertical impingement angle α as the arcsine of the second coordinate r_{y} of the reflection vector r divided by the norm of the reflection vector r and the horizontal impingement angle β as the arctangent of the first coordinate rₓ of the reflection vector r divided by the third coordinate r_{z} of the reflection vector r. Accordingly, the impingement angles α, β may be determined in many further ways. It is noted that for non-flat scanning areas 3, the impingement angles α, β may optionally be determined for each impingement point separately, e.g., in a local coordinate system at these impingement points.

As indicated in FIG. 1, the electric circuit 12 may transmit the impingement angles α, β to the light source driver 11 for controlling the light source 6 in dependence thereon, e.g., similarly as described above for the (unrotated) reflection vector r. For instance, assuming a B×A pixel image 2, a column index of the pixel P to be retrieved may be computed as ((β−βₘᵢₙ)/(βₘₐₓ−βₘᵢₙ))·B, and a row index of the pixel P to be retrieved may be computed as ((α−αₘᵢₙ)/(αₘₐₓ−αₘᵢₙ))·A, with βₘₐₓ and αₘₐₓ denoting the maximum value βₘᵢₙ and αₘᵢₙ denoting the minimum value of the respective impingement angle α, β. Of course, other computations of the pixel P on the basis of the impingement angles α, β may be employed, for instance, a computation based on another linear or a non-linear assignment of the impingement angles α, β to the pixel indices or to the memory addresses of the pixels.

As mentioned above, the input 14 obtains the coordinates nₓ, n_{y}, n_{z} of the mirror normal vector n. To this end, the input 14 is connected to a sensor 42 as shown in FIG. 1. The sensor 42 may optionally be—at least partially—included in the electric circuit 12. In one embodiment, the sensor 42 may directly sense the mirror normal vector n and transmit the same to the input 14. In the embodiment of FIG. 1, the sensor 42 senses (here: from a driving signal of the mirror driver 8) a first oscillation angle ε (FIG. 3) of the mirror 7 about the first oscillation axis 9 and a second oscillation angle ζ of the mirror 7 about the second oscillation axis 10, and the input 14 obtains the mirror normal vector n from the oscillation angles ε, ζ (by computation. Hence, the “obtaining” of the mirror normal vector n is in any case based on sensed data, which is either the mirror normal vector n itself or an indicator of the mirror normal vector n such as the oscillation angles ε, ζ.

FIG. 9 depicts an exemplary computation of the coordinates nₓ, n_{y}, n_{z} of the mirror normal vector n by means of the electric circuit 12 from the sensed oscillation angles ε, ζ that are received by the input 14. To this end, the input 14 has a transformation sub-circuit 43 which comprises a first sine unit 44 that computes a sine sinε of the first oscillation angle ε to obtain the first coordinate nₓ of the mirror normal vector n, a first cosine unit 45 that computes a cosine cosε of the first oscillation angle ε, a second sine unit 46 that computes the sine sinζ of the second oscillation angle ζ and a second cosine unit 47 that computes a cosine cosζ of the second oscillation angle ζ. The transformation sub-circuit 43 further comprises a first multiplier 48 that is connected to the first cosine unit 45 and to the second sine unit 46 and multiplies the cosine cosε of the first oscillation angle ε by the sine sinζ of the second oscillation angle ζ and by minus one to obtain the second coordinate n_{y} of the mirror normal vector n. The transformation sub-circuit 43 also comprises a second multiplier 49 that is connected to the first cosine unit 45 and the second cosine unit 47 and multiplies the cosine cosε of the first oscillation angle ε by the cosine cosζ of the second oscillation angle ζ to obtain the third coordinate n_{z} of the mirror normal vector n. The computed mirror normal vector n may then be used as described above with respect to FIGS. 1-8.

Optionally, the sensor 42 or a further sensor may sense the incidence vector i and/or the orientation angles γ, δ (including sensing their sine and cosine). In most embodiments, these values are not affected by the mirror oscillation and, in this case, may be provided to the input 14 after a single sensing or a measuring by hand.

It is noted that the above-mentioned embodiments, in particular the ones shown in FIGS. 1-9, may be combined in any sensible way. FIG. 10 schematically depicts an exemplary combination of the embodiments of FIGS. 7-9 for determining the impingement angles α, β of several light beams 4, e.g. of the colours red, green and blue. In the example of FIG. 10, the electric circuit 12 comprises one transformation sub-circuit 43 which computes the current mirror normal vector n from the current oscillation angles ε, ζ. The electric circuit 12 further comprises, for each colour, a respective group 50 of sub-circuits, i.e., a red group 50ᵣ for the red colour (each sub-circuit and vector of the red group 50ᵣ being marked with the index “r”), a green group 50_{g} and a blue group 50_{b} (each sub-circuit and vector of the green and blue groups 50_{g}, 50_{b} being marked accordingly). Each group 50ᵣ, 50_{g}, 50_{b} has a respective projection sub-circuit 22ᵣ, 22_{g}, 22_{b} each of which determines the respective one of the projection vectors pᵣ, p_{g}, p_{b} from the common mirror normal vector n and the respective one of the incidence vectors iᵣ, i_{g}, i_{b}. Each group 50ᵣ, 50_{g}, 50_{b} further has a respective summation sub-circuit 27ᵣ, 27_{g}, 27_{b} each of which determines the respective one of the reflection vectors rᵣ, r_{g}, r_{b} from the respective projection and incidence vectors pᵣ, p_{g}, p_{g}, iᵣ, i_{g}, i_{b}. Downstream the summation sub-circuit 27ᵣ, 27_{g}, 27_{b} each group 50ᵣ, 50_{g}, 50_{b} has a respective rotation sub-circuit 32ᵣ, 32_{g}, 32_{b} each of which determines the respective one of the (here: second; alternatively: first) rotated reflection vectors rᵣ″, r_{g}″, r_{b}″ from the respective reflection vector rᵣ, r_{g}, r_{b} and the common orientation angles γ, δ. Finally, each group 50ᵣ, 50_{g}, 50_{b} has a respective transformation sub-circuit 39ᵣ, 39_{g}, 39_{b} each of which determines the respective two of the six impingement angles aᵣ, Bᵣ, a_{g}, B_{g}, α_{b}, β_{b} of the light beams 4ᵣ, 4_{g}, 4_{b}. Alternatively to the embodiment shown, each group 50ᵣ, 50_{g}, 50_{b} may not comprise the rotation and/or transformation sub-circuits 32ᵣ, 32_{g}, 32_{b}, 39ᵣ, 39_{g}, 39_{b}, e.g., when the scanning area 3 is not inclined or when no impingement angles are required, etc.

The above-mentioned determinations may be carried out once for a single mirror orientation or repeatedly. For instance, the electric circuit 12 may optionally determine the reflection vector r (r′, r″) and/or the impingement angles α, β continuously, for successive orientations of the mirror 7, such that the light source 6 may be controlled on-the-fly, at each mirror orientation, according to the desired pixel P.

The electric circuit 12 is a hardware circuit which may be analogue and/or digital and may be embodied as a field-programmable gate array (FPGA), as an application specific integrated circuit (ASIC), or the like.

The disclosed subject matter is not restricted to the specific embodiments disclosed herein, but encompasses all variants, modifications and combinations thereof that fall within the scope of the appended claims.

What is claimed is:

1. An electric circuit for determining a reflection vector of a light beam incident on and reflected by an oscillating mirror, comprising
an input configured to obtain coordinates of a normalised mirror normal vector of the oscillating mirror and of an incidence vector of the incident light beam in a common three-dimensional coordinate system;
a projection sub-circuit connected to the input and configured to compute a dot product of said mirror normal vector and said incidence vector from the obtained coordinates and to compute each coordinate of a projection vector as a product of the respective coordinate of the mirror normal vector and said dot product times minus two; and
a summation sub-circuit connected to the input and to the projection sub-circuit and configured to add the computed projection vector to the incidence vector to determine the reflection vector of the light beam.

2. The electric circuit according to claim 1, wherein the projection sub-circuit, for computing the dot product, comprises
a first multiplier group having a first multiplier configured to multiply first coordinates of the mirror normal vector and the incidence vector to determine a first product, a second multiplier configured to multiply second coordinates of the mirror normal vector and the incidence vector to determine a second product, and a third multiplier configured to multiply third coordinates of the mirror normal vector and the incidence vector to determine a third product, and
an adder configured to add said first, second and third products to determine said dot product.

3. The electric circuit according to claim 1, wherein the projection sub-circuit, for computing the projection vector, comprises
a multiplicator configured to multiply said dot product by minus two to determine a scaled dot product, and
a second multiplier group having a first multiplier configured to multiply the first coordinate of the mirror normal vector by the scaled dot product to determine a first coordinate of the projection vector, a second multiplier configured to multiply the second coordinate of the mirror normal vector by the scaled dot product to determine a second coordinate of the projection vector, and a third multiplier configured to multiply the third coordinate of the mirror normal vector by the scaled dot product to determine a third coordinate of the projection vector.

4. The electric circuit according to claim 1, wherein the summation sub-circuit, for determining the reflection vector, comprises a first adder configured to add the first coordinate of the projection vector to the first coordinate of the incidence vector to determine a first coordinate of the reflection vector, a second adder configured to add the second coordinate of the projection vector to the second coordinate of the incidence vector to determine a second coordinate of the reflection vector, and a third adder configured to add the third coordinate of the projection vector to the third coordinate of the incidence vector to determine a third coordinate of the reflection vector.

5. The electric circuit according to claim 1, wherein the input is further configured to obtain a sine and a cosine of each of a first or a second or both the first and the second orientation angle indicating an orientation of a scanning area, and wherein the electric circuit comprises a rotation sub-circuit connected to the input and to the summation sub-circuit and configured to rotate the determined reflection vector about said first or said second or both said first and said second orientation angle.

6. The electric circuit according to claim 5, wherein the rotation sub-circuit, for rotating the reflection vector about said first orientation angle, comprises
a first multiplier configured to multiply the sine of the first orientation angle by the third coordinate of the reflection vector to determine a first summand,
a second multiplier configured to multiply the cosine of the first orientation angle by the first coordinate of the reflection vector to determine a second summand,
a first adder configured to add the first and second summands to determine a first coordinate of the reflection vector rotated about the first orientation angle,
a third multiplier configured to multiply the cosine of the first orientation angle by the third coordinate of the reflection vector to determine a third summand,
a fourth multiplier configured to multiply the sine of the first orientation angle by the first coordinate of the reflection vector to determine a fourth summand, and
a second adder configured to add the third summand and a negative of the fourth summand to determine a third coordinate of the reflection vector rotated about said first orientation angle.

7. The electric circuit according to claim 6, wherein the rotation sub-circuit, for rotating the reflection vector further about said second orientation angle, comprises
a fifth multiplier configured to multiply the sine of the second orientation angle by the third coordinate of the reflection vector rotated about said first orientation angle to determine a fifth summand,
a sixth multiplier configured to multiply the cosine of the second orientation angle by the second coordinate of the reflection vector rotated about said first orientation angle to determine a sixth summand,
a third adder configured to add the sixth summand and a negative of the fifth summand to determine a second coordinate of the reflection vector rotated about said second orientation angle,
a seventh multiplier configured to multiply the cosine of the second orientation angle by the third coordinate of the reflection vector rotated about said first orientation angle to determine a seventh summand,
an eighth multiplier configured to multiply the sine of the second orientation angle by the second coordinate of the reflection vector rotated about said first orientation angle to determine an eighth summand,
a fourth adder configured to add the seventh and eighth summands to determine a third coordinate of the reflection vector rotated about said second orientation angle.

8. The electric circuit according to claim 1, further comprising an angle determination sub-circuit configured to determine, from the determined reflection vector, a vertical and a horizontal impingement angle of the light beam on the scanning area, seen from the scanning area.

9. The electric circuit according to claim 1, configured to determine said reflection vector or said impingement angles repeatedly for successive orientations of the oscillating mirror.

10. The electric circuit according to claim 1, wherein the input comprises a transformation sub-circuit and is configured to receive a first oscillation angle of said mirror about a first axis and a second oscillation angle of said mirror about a second axis, wherein the transformation sub-circuit is configured to obtain the coordinates of the mirror normal vector by computation from the first and second oscillation angles.

11. The electric circuit according to claim 10, wherein the transformation sub-circuit comprises
a first sine unit configured to compute a sine of the first oscillation angle to obtain the first coordinate of the mirror normal vector,
a first cosine unit configured to compute a cosine of the first oscillation angle,
a second sine unit configured to compute a sine of the second oscillation angle,
a second cosine unit configured to compute a cosine of the second oscillation angle,
a first multiplier connected to the first cosine unit and the second sine unit and configured to multiply the cosine of the first oscillation angle by the sine of the second oscillation angle and by minus one to obtain the second coordinate of the mirror normal vector, and
a second multiplier connected to the first cosine unit and the second cosine unit and configured to multiply the cosine of the first oscillation angle by the cosine of the second oscillation angle to obtain the third coordinate of the mirror normal vector.

12. The electric circuit according to claim 10, comprising one transformation sub-circuit and at least two groups of sub-circuits, each group having at least one projection sub-circuit and one summation sub-circuit,
wherein each group is connected to the transformation sub-circuit and configured to determine the reflection vector of a respective light beam.

13. The electric circuit according to claim 1, further comprising a sensor connected to the input and configured to sense at least one of the coordinates of the incidence vector, the coordinates of the mirror normal vector, the first oscillation angle, the second oscillation angle, the first orientation angle and the second orientation angle, and to transmit the same to the input.

14. The electric circuit according to claim 1, further comprising a light source driver configured to drive a light source emitting said light beam/s in dependence on the determined reflection vector or impingement angles.

15. A projector for projecting an image comprised of pixels onto a scanning area, comprising
a light source configured to emit a light beam carrying said image;
a mirror configured to oscillate about two axes in order to reflect the light beam across the scanning area in order to project the image onto the scanning area; and
an electric circuit according to claim 14, wherein the light source driver is connected to the light source to drive the same in order to project, for each determined reflection vector or pair of impingement angles, the desired pixel of the image.

16. The electric circuit according to claim 9, configured to determine said reflection vector or said impingement angles continuously for successive orientations of the oscillating mirror.
